(19) United States
(12) Patent Application Publication
(10) Pub. No.: US 2026/0360162 A1
(43) Pub. Date: Nov. 12, 2026

(54) METHOD FOR DETECTING A LIVING BEING

(71) Applicant: Valeo Comfort and Driving Assistance, Créteil (FR)

(72) Inventors: Nadjah Touati, Créteil (FR); Tarek Kasmieh, Créteil (FR)

(73) Assignee: Valeo Comfort and Driving Assistance, Créteil (FR)

(21) Appl. No.: 19/491,185

(22) PCT Filed: May 17, 2024
(86) PCT No.: PCT/EP2024/063765

§ 371 Date: Dec. 8, 2025

(30) Foreign Application Priority Data
Jun. 8, 2023 (FR) 2305778

(51) Int. Cl. G06V 20/59; G01S 7/35; G01S 13/89; G06F 16/55; G06V 10/764; G06V 40/10

(52) U.S. Cl. CPC G06V 20/59; G01S 7/356; G01S 13/89; G06F 16/55; G06V 10/764; G06V 40/10

(57) ABSTRACT

Described is a method for detecting a living being. Multiple images within a time window are acquired. Each image includes a series of data with which a position, a power, and a speed are associated. A first database of instantaneous data from the images is constructed. The instantaneous data is based on the position, power, and speed of each data item of each image acquired in the time window. A second database of time data from the images is constructed. The time data is calculated from a periodic signal of each image recorded over a moving time window. The first database and the second database are applied as input to a machine learning model. The machine learning model is executed, and classification by the machine learning model regarding the presence or absence of a living being is established. Depending on the classification, corresponding information is transmitted to a management unit.

The present invention relates to a method for detecting a living being. It is particularly, but non-limitingly, applicable to motor vehicles.

In the field of motor vehicles, one method for detecting a living being inside a vehicle that is known to those skilled in the art comprises analyzing breathing frequency from the change in a power signal or phase over time and comparing it with a breathing pattern of a living being. This makes it possible in particular to trigger an alarm system when an occupant, in particular a child, is left behind in the vehicle.

A drawback of this prior art is that the dependence on a clear breathing signal pattern may be masked by any movement of the body of the living being. Moreover, the patterns of movement of the body of living beings are difficult to model because of their variability and the detection algorithms used are generally based on simply checking the signal-to-noise ratio so as to detect high-energy movements of living beings (i.e. with a high signal-to-noise ratio). However, this type of detection may be confused with external effects (vibrations of the vehicle, jolts of the vehicle, etc.) which generate energy comparable to a movement of a living being and may easily lead to false alarms, called true negative cases.

In this context, the present invention aims to provide a method for detecting a living being which makes it possible to overcome the mentioned drawback.

To this end, the invention provides a method for detecting a living being, characterized in that said detection method comprises:
acquiring a plurality of images in a time window, each image comprising a series of data with which a position, a power and a speed are associated,
constructing a first database of instantaneous data from the plurality of images, said instantaneous data being based on said position, said power and said speed of each datum of each image acquired in said time window,
constructing a second database of time data from said plurality of images, said time data being calculated from a periodic signal of each image recorded over a moving time window,
applying said first database and said second database as input to a machine learning model,
executing said machine learning model,
establishing a classification by said machine learning model as to the presence/absence of a living being,
transmitting corresponding information to a management unit as a function of said classification.

Thus, as will be seen in detail below, the detection method is based on the introduction of a time characteristic. This time characteristic takes into account changes in radar images over time. The objective is to have a characteristic which reflects any periodic or oscillation pattern of a signal (breathing for example) and to use it to improve detection accuracy. One of the advantages over conventional detection methods is that this characteristic is not used alone but combined with other characteristics based on a single radar image and, therefore, the final decision does not depend solely on a single characteristic as in the case of conventional detection methods.

According to non-limiting embodiments, said detection method may further comprise one or more additional features, taken alone or in any technically possible combination, from among the following.

According to one non-limiting embodiment, the instantaneous data are:
average values of said position and/or of said power and/or of said speed of said data of each image, or
variances in said data of each image.

According to one non-limiting embodiment, said machine learning model is a supervised model.

According to one non-limiting embodiment, said supervised model is a support vector machine or a random forest.

According to one non-limiting embodiment, said periodic signal is breathing or a heartbeat.

According to one non-limiting embodiment, said living being is of adult, child or animal type.

According to one non-limiting embodiment, said time window is about five seconds.

According to one non-limiting embodiment, the time data are a maximum power or a phase change of said periodic signal.

According to one non-limiting embodiment, the construction of said second database comprises:
storing the time data in a buffer memory so as to obtain a plurality of time values,
suppressing the direct component of said time values,
applying a Fourier transform to said time values so as to obtain frequency values,
extracting, from said frequency values, a maximum value in a given frequency range.

According to one non-limiting embodiment, said given frequency range is a breathing frequency range or a heartbeat frequency range.

According to one non-limiting embodiment, the construction of said second database further comprises normalizing said frequency values before said extraction of said maximum value.

According to one non-limiting embodiment, said plurality of images are obtained from waves received by a wave-transmitting/receiving entity of a sensor.

According to one non-limiting embodiment, said moving time window is three images per second.

According to one non-limiting embodiment, said detection method is a method for detecting a living being inside a vehicle.

According to one non-limiting embodiment, the series of data is a series of points.

According to one non-limiting embodiment, the images are images acquired inside a vehicle.

According to one non-limiting embodiment, said periodic signal is representative of a type of living being.

According to one non-limiting embodiment, the sensor is a radar sensor.

According to one non-limiting embodiment, the images are radar images.

According to one non-limiting embodiment, the moving time window has the same duration as the time window.

Furthermore, a system for detecting a living being is provided, characterized in that said detection system comprises:
(a) a sensor configured to acquire a plurality of images in a time window, each image comprising a series of data with which a position, a power and a speed are associated,
(b) a processing unit configured to:
construct a first database of instantaneous data from the plurality of images, said instantaneous data being based on said position, said power and said speed of each datum of each image acquired in said time window,
construct a second database of time data from said plurality of images, said time data being calculated from a periodic signal of each image recorded over a moving time window,
apply said first database and said database as input to a machine learning model,
execute said machine learning model,
(c) said machine learning model configured to be executed and establish a classification as to the presence/absence of a living being,
said processing unit being further configured to transmit corresponding information to a management unit as a function of said classification.

The invention and the various applications thereof will be better understood on reading the following description and studying the accompanying figures:

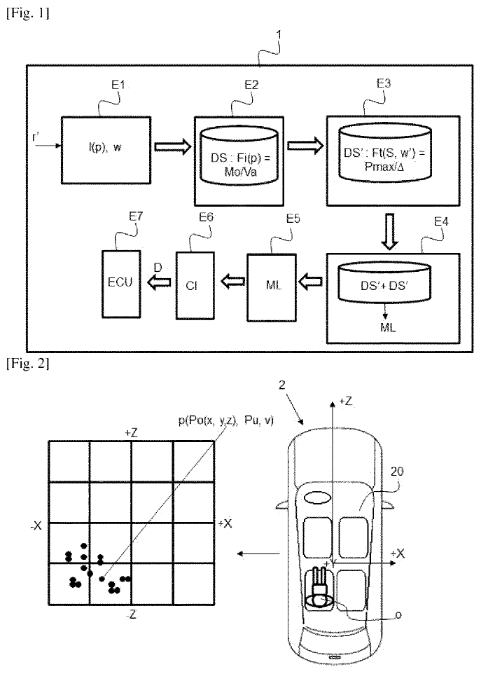

FIG. 1 illustrates a diagram of a method for detecting a living being, according to one non-limiting embodiment of the invention,

FIG. 2 illustrates one non-limiting example of a radar image acquired by a radar image acquisition step of the detection method of FIG. 1, said radar image comprising a plurality of points,

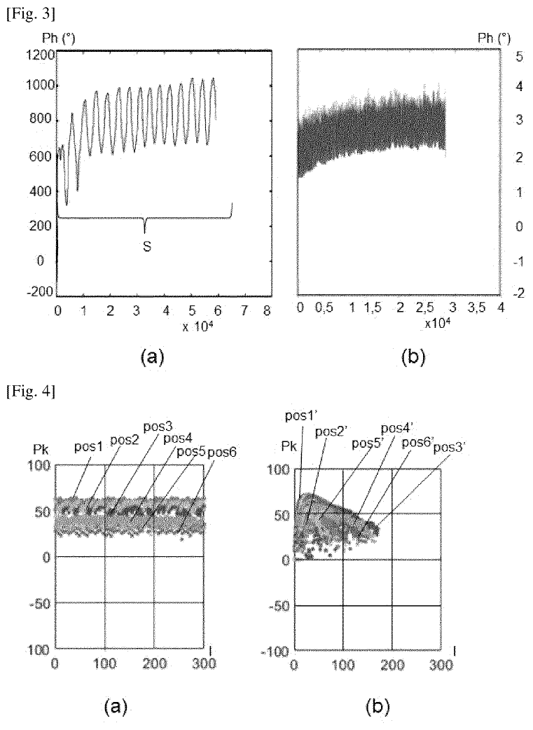

FIG. 3 illustrates a first graph which illustrates a phase change in a periodic signal corresponding to the breathing or to the heartbeat of a living being and a second graph which illustrates noise in the absence of a living being, according to one non-limiting embodiment,

FIG. 4 illustrates a first graph which illustrates a power level of a periodic signal corresponding to the breathing of a child, and a second graph which illustrates a power level of a bottle of water, according to one non-limiting embodiment,

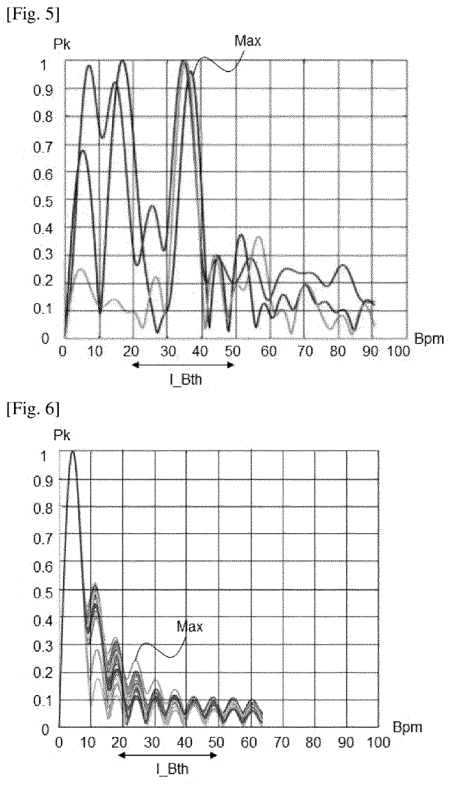

FIG. 5 illustrates a spectrum of the first graph of FIG. 4, according to one non-limiting embodiment,

FIG. 6 illustrates a spectrum of the second graph of FIG. 4, according to one non-limiting embodiment,

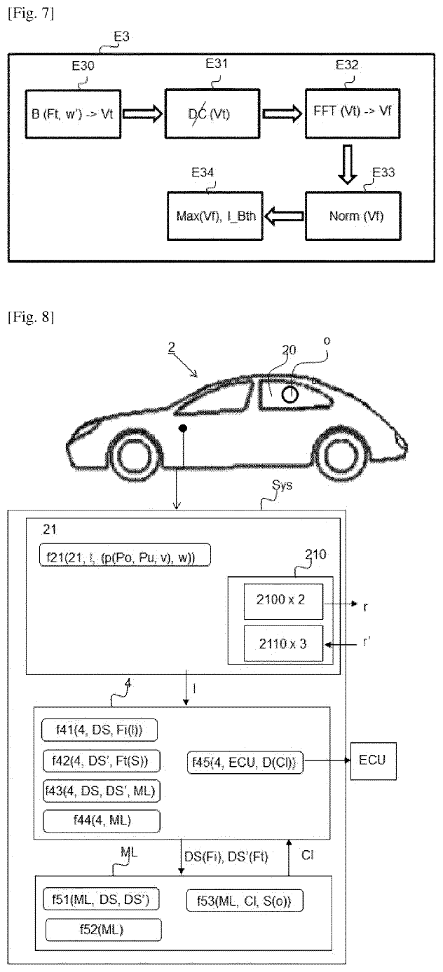

FIG. 7 illustrates a diagram of a step of constructing a database of time data of said detection method of FIG. 1, according to one non-limiting embodiment,

FIG. 8 illustrates a system for detecting a living being, configured to implement the detection method of FIG. 1, according to one non-limiting embodiment.

Elements that are identical, in structure or in function, and that appear in various figures keep the same reference signs, unless specified otherwise.

The method 1 for detecting a living being o according to the invention is described with reference to FIGS. 1 to 7. In one non-limiting embodiment, the living being o is located in a passenger compartment 20 of a vehicle 2, i.e. inside the vehicle 2. This non-limiting embodiment is used throughout the remainder of the description. In FIG. 2, the living being o is located on a rear seat in one non-limiting example. Thus, the detection method 1 makes it possible in particular to detect a living being o in a vehicle 2. In one non-limiting embodiment, the vehicle 2 is a motor vehicle. “Motor vehicle” is understood to mean any type of motorized vehicle. This embodiment is used as a non-limiting example throughout the remainder of the description. Throughout the remainder of the description, the vehicle 2 is thus also called motor vehicle 2.

As illustrated in FIG. 1, the detection method 1 comprises the following steps.

In a step E1, a plurality of images I are acquired by a sensor 21 in a time window w. In one non-limiting embodiment, the sensor 21 is a radar sensor. The images I are therefore radar images I in this case. This non-limiting embodiment is used as a non-limiting example throughout the remainder of the description. In one non-limiting embodiment, the time window w is about five seconds. It is less than 10 seconds according to the EuroNCAP specification for automotive application. As illustrated in FIG. 2, each radar image I comprises a series of data p with which a position Po, a power Pu and a speed v are associated. The position Po is defined by the x, y and z Cartesian parameters or by the radius (or distance), azimuth and elevation parameters. In one non-limiting embodiment, the data p are points. This non-limiting embodiment is used as a non-limiting example throughout the remainder of the description. It will be noted that the acquisition (in milliseconds) of a single radar image is done in an acquisition window called a “frame”.

The plurality of radar images I are obtained from radar waves r′ received by a radar wave-transmitting/receiving entity 210 of the radar sensor 21, which is configured to transmit radar waves r (which are millimeter waves) and in return receive radar waves r′ (which are millimeter waves) which have been reflected on a target object, such as a living being o.

On the basis of the radar waves r′, a Fourier transform FFT is applied by a processing unit (not illustrated) of the radar sensor 21 so as to calculate the reflection distances on the target object, for example according to a time-of-flight algorithm known to those skilled in the art. This process known to those skilled in the art is called “range processing”. It is not illustrated in the figures.

On the basis of the data obtained by the Fourier transform, the processing unit of the radar sensor 21 calculates peaks of the reflection distances by suppressing the peaks which have not moved over the time window w. This process known to those skilled in the art is called “clutter removal”. It is not illustrated in the figures.

Obtained in this way is a radar image I with points p and the information about these points p, i.e. their position Po, their power Pu and/or their speed v.

In the context of application in a vehicle, the radar images I are images acquired inside the motor vehicle 2, i.e. in its passenger compartment 20.

In a step E2, a first database DS of instantaneous data Fi is constructed by a processing unit 4 from the plurality of radar images I. The instantaneous data Fi (otherwise called instantaneous characteristics Fi) are based on the position Po, the power Pu and/or the speed v of each point p of each radar image I acquired in said time window w.

In non-limiting embodiments, the instantaneous data Fi are:
the average values of the position Po, power Pu and speed v data of the points p of each radar image I,
the variances Va in the position Po, power Pu and speed v data of the points p of each radar image I.

In addition to instantaneous data Fi, time data Ft are used as described below. The idea of using time data Ft (otherwise called time characteristics Ft) comes from the fact that a radar image I of a target object, here a living being o, can show periodic patterns, in particular in the case of breathing or heart rate. The time data Ft are thus calculated from a periodic signal S. In non-limiting embodiments, the periodic signal S is thus breathing or a heart rate (corresponding to beats of the heart).

These periodic patterns can be detected in the phase Ph of the signal received by the radar sensor 21 as shown in drawing (a) of FIG. 3 which is compared to an empty environment (here the passenger compartment 20 of the motor vehicle 2) in drawing (b) of FIG. 3. The periodic signal S illustrated in drawing (a) of FIG. 3 illustrates a periodic pattern of the phase Ph of a living being, here an adult, over a moving time window w′. In FIG. 3, the abscissa represents the signal transmitted in a transmission window, called “chirp”, the transmission being done periodically, and the ordinate represents the phase Ph in degrees (°). The transmission “chirps” (in microseconds) make it possible to construct the radar image I of each acquisition window. In one acquisition window, there are a plurality of transmission “chirps”.

The same periodic pattern can be extracted from the change in the power over time which is due to the periodic movement of the breathing or the heart rate of a living being o. Specifically, the power changes periodically because of the reciprocating movement of the breathing or the heart rate of the living being o who is moving toward and who is moving away from the radar wave-transmitting/receiving entity 210 of the radar sensor 21.

Drawing (a) of FIG. 4 illustrates one non-limiting example of a child in various positions inside the motor vehicle 2, the various positions pos1, pos2, pos3, pos4, pos5, pos6 being illustrated by different shaded colors. The pattern is compared to a true negative pattern (drawing (b)) which uses a bottle of water which is shaken about in the motor vehicle 2, these various positions pos1′, pos2′, pos3′, pos4′, pos5′, pos6′ also being illustrated by different shaded colors. The maximum power Pk of the radar image I is represented on the abscissa. The number of radar images I is represented on the ordinate. Drawing (a) illustrates the change in power of a periodic signal S over a moving window w′ corresponding to the breathing or a heartbeat of a living being o, who is a child here, at various positions here in the passenger compartment 20 of the motor vehicle 2. Drawing (b) thus illustrates the change in power of an inert object, here a bottle of water, at various positions here in the passenger compartment 20 of the motor vehicle 2. As can be seen, the power levels are similar in both cases but the change is different over time, i.e. the periodic pattern.

Thus, in a step E3, a second database DS′ of time data Ft is constructed by the processing unit 4 from the plurality of radar images I. The time data Ft are calculated from a periodic signal S of each radar image I recorded over the moving time window w′. In a moving time window w′, there will thus be a periodic signal S of a plurality of radar images I. It will be noted that the moving time window w′ has the same duration as the time window W.

In one non-limiting embodiment, the moving time window w′ is three radar images I per second. This makes it possible to have a change in the time data Ft over time that is enough to be able to differentiate cases of true positives (living being o) from cases of true negatives (moving inert object).

It will be noted that step E3 may be carried out in parallel with step E2 or before step E2.

In one non-limiting embodiment, the time data Ft are a maximum power Pmax or a phase change A of said periodic signal S.

As illustrated in FIG. 7, in one non-limiting embodiment, the construction of the second database DS′ comprises:
in a sub-step E30, storing the time data Ft in a buffer memory B so as to obtain a plurality of time values Vt,
in a sub-step E31, suppressing the direct DC component of said time values Vt,
in a sub-step E32, applying a Fourier transform FFT to said time values Vt so as to obtain frequency values Vf,
in a sub-step E34, extracting, from said frequency values Vf, a maximum value Max in a given frequency range I_Bth.

Thus, for each radar image I, the maximum power Pmax or phase change Δ information is calculated according to a history owing to the moving time window w′.

In one non-limiting embodiment, the buffer memory B has a size for ten radar images I, this corresponding to about three seconds if the moving time window w′ is three radar images I per second.

The application of the Fourier transform FFT makes it possible to transition from the time domain to the frequency domain.

Thus, the instantaneous signal (phase change or maximum power) of each acquisition window (“frame”) is stored for a certain number of frames in the moving time window w′, and the periodicity is calculated by performing a frequency analysis of this stored signal.

It will be noted that the suppression of the direct DC component makes it possible to remove the average value of the periodic signal S and to keep only the sinusoidal signal. Since the process of suppressing a direct DC component is known to those skilled in the art, it is not described here.

In non-limiting embodiments, the given frequency range I_Bth is a breathing frequency range or a heartbeat frequency range.

In other words, for each radar image I, the maximum value Max that is found on all the harmonics of the given frequency range I_Bth is extracted. The maximum value Max is a power. The frequency of the maximum value Max represents the frequency and therefore the periodicity of the maximum power Pmax or of the phase change Δ that are seen above.

In one illustrated non-limiting embodiment, the construction of said second database DS′ further comprises:
in a sub-step E33, the normalization Norm of said frequency values Vf before said extraction of said maximum value Max. This makes it possible to make the calculations simpler. Since the process of normalization is known to those skilled in the art, it is not described here.

To start the execution of the machine learning model ML (described later), it is necessary to wait until the buffer memory B is filled with the time data Ft. Thus, in one non-limiting embodiment, there is a normalized frequency value equal to 0.5. This value makes it possible to start on a neutral value which does not indicate whether there is a living or inert object. It will be noted that a normalized frequency value equal to 0 corresponds to an inert object (something which therefore does not breathe).

FIG. 5 illustrates one non-limiting example of normalization of the first graph (drawing (a)) of FIG. 4. The frequency band of the breathing in Bpm is found on the abscissa and the power Pk on the ordinate. FIG. 5 highlights the difference in the case of a child and of a bottle of water of which the normalization (of the second graph (drawing (b) of FIG. 4) is illustrated in FIG. 6. As can be seen, the highest value Max in the breathing frequency band I_Bth in the case of a child is about 1, while for a bottle of water it is about 0.2.

In a step E4, the first database DS and the second database DS′ are applied by the processing unit 4 as input to a machine learning model ML. Thus, there will be a first entry with all the instantaneous data Fi (of all the points p of the radar image I) acquired in the time window w, and a second entry with all the time data Ft which have been accumulated in the buffer memory B, i.e. all the time data Ft of all the periodic signals S of each radar image I acquired over the moving time window w′.

In one non-limiting embodiment, the machine learning model ML is a supervised model. In non-limiting embodiment variants, the supervised model is a support vector machine or a random forest. Since the functioning of these supervised models is known by those skilled in the art, they are not described here.

In a step E5, the machine learning model ML is executed.

In a step E6, the machine learning model ML establishes a classification CI as to the presence/absence of a living being o. It will be noted that the periodic signal S is in particular representative of a type of living being o. In non-limiting embodiments, the type of living being o encompasses that of a child, that of an adult, or that of an animal. Consequently, the time data Ft which are calculated from the periodic signal S and which are used as input to the machine learning model ML are also representative of the type of living being o. Thus, as output from the machine learning model ML, in one non-limiting embodiment, there will be a classification CI associated with the radar images I taken inside the motor vehicle 2 which will indicate whether they correspond to a living being o or not and, if so, to what type (adult, child, animal).

It will be noted that the machine learning model ML will have been trained beforehand with at least one database of instantaneous data Fi (different from the first database DS) of true positive cases and of true negative cases and labels associated with the true positive cases and with the associated true negative cases, and a database of time data Ft (different from the second database DS′) of true positive cases and of associated true negative cases and labels associated with the true positive cases and with the associated true negative cases.

Thus, the time data Ft make it possible to differentiate a living being o from an inert object but also the type of living being o (adult, child, animal) because the periodic patterns (breathing or heart rate) represented by the periodic signals S are different for these various types of living being o.

In a step E7, the processing unit 4 transmits corresponding information D (absence/presence of a living being o) to a management unit ECU as a function of the classification Cl. In one non-limiting embodiment, the management unit ECU is an electronic control unit 2 of the motor vehicle 2.

Depending on the decision D, in one non-limiting embodiment, the management unit ECU may trigger an alarm so as to warn that there is a living being o in the motor vehicle 2.

Thus, the method 1 for detecting a living being o is implemented by a system Sys for detecting a living being o illustrated in FIG. 8.

The detection system Sys comprises a radar sensor 21 configured to acquire a plurality of radar images I in a time window w, each radar image I comprising a series of points p with which a position Po, a power Pu and a speed v are associated (illustrated function f21(21, I, (p(Po, Pu, v), w)).

The radar sensor 21 comprises a radar wave-transmitting/receiving entity 210. In non-limiting embodiments, the radar wave-transmitting/receiving entity 210 comprises, as illustrated in FIG. 8:
two transmitting antennas 2100 configured to transmit radar waves r,
three receiving antennas 2110 configured to receive in return radar waves r′ which have been reflected on a target object, such as a living being o.

The detection system Sys further comprises a processing unit 4 configured to:
construct a first database DS of instantaneous data Fi from the plurality of radar images I, said instantaneous data Fi being based on said position Po, said power Pu and said speed v of each point p of each radar image I acquired in said time window w (illustrated function f41(4, DS, Fi(I)),
construct a second database DS′ of time data Ft from the plurality of radar images I, the time data Ft being calculated from a periodic signal S of each radar image I recorded over a moving time window w′ (illustrated function f42(4, DS′, Ft(S)),
apply this first database DS and this second database DS′ as input to a machine learning model ML (illustrated function f43(4, DS, DS′, ML)),
execute said machine learning model ML (illustrated function f44(4, ML)).

The processing unit 4 is further configured to transmit corresponding information D to a management unit ECU as a function of said classification Cl (illustrated function f45(4, ECU, D(CI))).

The detection system Sys further comprises said machine learning model ML which is configured to:
receive as input the data Fi, Ft from the first database DS and the second database, respectively (illustrated function f51(ML, DS, DS′)),
be executed (illustrated function f52(ML)),
establish a classification Cl as to the presence/absence of a living being o (illustrated function f53(ML, Cl, S(o)).

Of course, the description of the invention is not limited to the embodiments described above and to the field described above. Thus, in one non-limiting embodiment, the detection method 1 may be applied to monitor the breathing or the heart rate of elderly people in hospitals. In this case, the management unit ECU is an electronic control unit of a medical monitoring device. And, in this case, as a function of the corresponding information D transmitted by the processing unit 4, in one non-limiting embodiment, the management unit ECU may trigger an alarm so as to warn that the living being o is no longer breathing or that their heart is no longer beating. Thus, in another non-limiting embodiment, the radar image I is a thermal map. Thus, in another non-limiting embodiment, the sensor 21 is an ultrasonic sensor.

Thus, the described invention in particular has the following advantages:
it allows for more reliable and more accurate detection of living beings o,
it allows the type of living being o to be identified,
combining instantaneous data Fi with time data Ft makes it possible to improve the detection of true positive cases and to reduce true negative cases and thus allows for a more robust differentiation between a living being o and an inert object; the detection method 1 is thus more robust. Thus, the detection rate and robustness with respect to false alarms are improved.

1. A method for detecting a living being, comprising:
acquiring a plurality of images in a time window, each image comprising a series of data with which a position, a power, and a speed are associated;
constructing a first database of instantaneous data from the plurality of images, wherein the instantaneous data is based on the position, the power, and the speed of each datum of each image acquired in said the time window;
constructing a second database of time data from the plurality of images, wherein the time data is calculated from a periodic signal of each image recorded over a moving time window;
applying the first database and the second database as input to a machine learning model;
executing the machine learning model;
establishing a classification by the machine learning model as to a presence or an absence of a living being; and
transmitting corresponding information to a management unit as a function of the classification.

2. The method as claimed in claim 1, wherein the instantaneous data are
average values of the position and/or of the power and/or of the speed of the data of each image, or
variances in the data of each image.

3. The method as claimed in claim 1, wherein the machine learning model is a supervised model.

4. The method as claimed in claim 3, wherein the supervised model is a support vector machine or a random forest.

5. The method as claimed in claim 1, wherein the periodic signal is breathing or a heartbeat.

6. The method as claimed in claim 1, wherein the living being is of adult, child or animal type.

7. The method as claimed in claim 1, wherein the time window is about five seconds.

8. The method as claimed in claim 1, wherein the time data are a maximum power or a phase change of the periodic signal.

9. The method as claimed in claim 1, wherein the construction of the second database comprises:
storing the time data in a buffer memory so as to obtain a plurality of time values;
suppressing a direct component of the plurality of time values;
applying a Fourier transform to the plurality of time values so as to obtain frequency values; and
extracting, from the frequency values, a maximum value in a given frequency range

10. The method as claimed in claim 9, wherein the given frequency range is a breathing frequency range or a heartbeat frequency range.

11. The method as claimed in claim 9, wherein the construction of the second database further comprises
normalizing the frequency values before extraction of the maximum value.

12. The method as claimed in claim 1, wherein the plurality of images are obtained from waves received by a wave-transmitting/receiving entity of a sensor.

13. The method as claimed in claim 1, wherein the moving time window is three images per second.

14. The method as claimed in claim 1, wherein the detection method is a method for detecting a living being inside a vehicle.

15. A system for detecting a living being, comprising:
a sensor configured to acquire a plurality of images in a time window, each image comprising a series of data with which a position, a power, and a speed are associated; and
a processing unit configured to:
construct a first database of instantaneous data from the plurality of images, wherein the instantaneous data is based on the position, said the power, and the speed of each datum of each image acquired in the time window;
construct a second database of time data from the plurality of images, wherein the time data is calculated from a periodic signal of each image recorded over a moving time window;
apply the first database and the second database (DS′) as input to a machine learning model;
execute the machine learning model,
wherein the machine learning model is configured to be executed and establish a classification as to a presence or an absence of a living being, and
wherein the processing unit is further configured to transmit corresponding information to a management unit as a function of the classification.
